(19) United States
(12) Patent Application Publication
(10) Pub. No.: US 2007/0169200 A1
(43) Pub. Date: Jul. 19, 2007

(54) [A PORTABLE STORAGE DEVICE WITH KEY OUTPUTTING FUNCTION]

(75) Inventors: Chih-Ling Wang, TAIPEI (TW); Chien-Yu Lin, TAIPEI (TW)

Correspondence Address: JIANQ CHYUN INTELLECTUAL PROPERTY OFFICE, 7 FLOOR-1, NO. 100, ROOSEVELT ROAD, SECTION 2, TAIPEI, 100, TW

(73) Assignee: PHISON ELECTRONICS CORP., Chutung Town (TW)

(21) Appl. No.: 11/306,861

(22) Filed: Jan. 13, 2006

(51) Int. Cl. H04N 7/16

(52) U.S. Cl. 726/26

(57) ABSTRACT

A portable storage device with key outputting function is disclosed. The portable storage device comprises a transmission interface for communicating with a host end; a plurality of key units; a microprocessor, electrically connected to the transmission interface and the key units; a memory unit electrically connected to the microprocessor, wherein the key units are adopted for generating and transmitting corresponding input signals to the microprocessor to lock/unlock said memory unit, and wherein after the memory unit is unlocked, the key units generates and transmits input signals to the microprocessor to convert the input signals into key signals corresponding to a keyboard and then the key signals are transmitted to the host end.

### BACKGROUND OF THE INVENTION

1. Field of the Invention

The present invention is generally related to a portable storage device with key outputting function, and more particularly, to a portable storage device with key outputting function comprising a plurality of key units to generate input signals.

2. Description of Related Art

With the rapid advancement of flash memory technology, storage capacity of a memory card and portable storage devices are being substantially upgraded. Especially, portable storage device with small size, larger storage capacity and high transmission speed has become essential for users.

As these electronic devices are designed to be lighter, thinner, shorter and smaller, they can easily misplaced. Accordingly, the data stored in the portable storage device may be stolen by unauthorized persons. Therefore, some manufacturers have developed security means, such as alphanumeric password, for protecting the data stored in the portable storage devices, wherein the password is required to access the protected data.

However, for inputting the password, the common portable storage device is required to be electrically connected to a keyboard, for example the number keys or the alphanumeric keys. When the portable storage device is electrically connected to the host end, for example the notebook computer or desktop computer, the user is required to input the password via the keyboard to unlock the portable storage device for retrieving or processing data stored therein.

However, it should be noted that the keyboard here is only used for the purpose of inputting the password. Therefore, how to overcome the above defects of the conventional art is an important issue for the manufacturers in the field.

### SUMMARY OF THE INVENTION

According to an aspect of the present invention, the portable storage device comprises a transmission interface to communicate with a host end and a plurality of key units, wherein the key units are adopted for generating and transmitting input signals, for example inputting a password to a microprocessor for unlocking a memory unit. After the memory unit is unlocked, the key units may be pressed for generating and transmitting input signals to the microprocessor to convert the input signals into key signals corresponding to a keyboard and are then transmitted to the host end via transmission interface. Thus, the host end receives the input signals that are identical to the keyboard to generate corresponding words or motions and thereby substantially add value to the application of the key units.

According to another aspect of the present invention, after the memory unit is unlocked, a control program of the memory unit will be executed automatically and installed in the host end to sense the input signals generated by the plurality of key units, and to convert the input signals into the key signals corresponding to the keyboard. Thus, the key units may be as a keyboard to input words or motions and thereby add value to the application of the key units.

### BRIEF DESCRIPTION OF THE DRAWING

FIG. 1 is a block diagram of a portable storage device according to an embodiment of the present invention.

FIG. 2 is a flowchart of a procedure of the portable storage device according to an embodiment of the present invention.

FIG. 3 is a block diagram of a portable storage device according to another embodiment of the present invention.

### DETAIL DESCRIPTION OF THE INVENTION

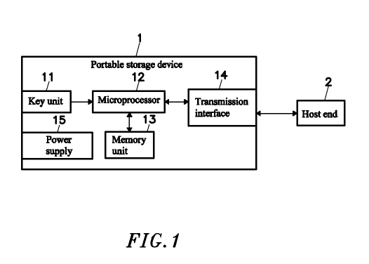

Referring to FIG. 1, a portable storage device 1 of the present invention comprises a plurality of key units 11, a microprocessor 12, a memory unit 13, a transmission interface 14 and a power supply 15.

The plurality of key units 11 is adopted for generating input signals by pressing and transmitting the input signals. The plurality of key units 11 may be button switches, micro-switches, connective proximity switches, touch switches, voltage switches, capacitor switches or mechanical switches.

The microprocessor 12 may be adopted for receiving the abovementioned input signals. After the microprocessor 12 receives the input signals, the microprocessor 12 can proceed a lock/unlock operation and also converts and transmits the input signals generated by the plurality of the key units 11 into key signals corresponding to a keyboard after proceeding the unlock operation.

The memory unit 13 can be locked/unlocked by the microprocessor 12 such that the memory unit 13 is rendered un-accessible/unreadable after being locked or rendered accessible/readable after being unlocked. The memory unit 13 may be an electrically programmable read only memory (EROM), an electrically erasable read only memory (EEROM), an erasable programmable read only memory (EPROM), an electrically erasable programmable read only memory (EEPROM), an flash memory (flash), an AND-flash memory, an OR-flash memory, a NAND-flash memory or a hard disk drive.

Furthermore, the microprocessor 12 may transmit data to a host end 2 via the transmission interface 14. The transmission interface 14 may be wired or wireless type. The wireless signal transmission protocol may be a ZigBee or a blue tooth. The wired connection may be an institute of electrical and electronic engineers standard bus interface (IEEE1394), a universal serial bus (USB), a serial advanced technology attachment (SATA), an integrated device electronics (IDE) or a small computer standard interface (SCSI).

It should be noted that the above-mentioned transmission interface 14 is merely used to describe the embodiment of the present invention and therefore should not be used to limit the scope of the present invention. Any equivalent component capable of transmitting signals between the microprocessor 12 and the host end 2 shall be construed to be within the scope of the present invention.

The power supply unit 15 is adopted for supplying power to the portable storage device 1 and may be comprised of a carbonized-zinc battery, a basic battery, a nickel-hydride battery or a lithium battery.

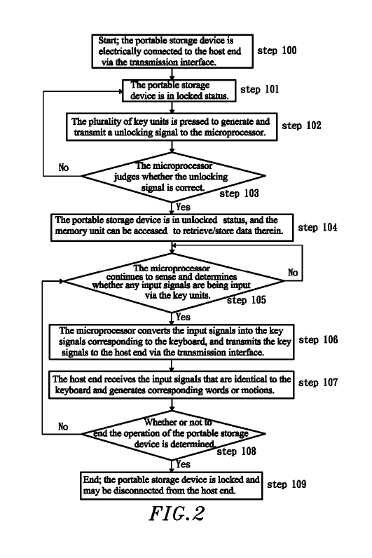

Hereinafter, the operation procedure of the portable storage device according to an embodiment of the present invention is described with reference to FIG. 1 and 2 as follows.

At step 100, the portable storage device 1 is electrically connected to the host end 2 via the transmission interface 14.

At step 101, the portable storage device 1 is locked, and a user may be asked to input a unlocking signal via the key units 11.

At step 102, the plurality of the key units 11 are pressed to generate and transmit the unlocking signal to the microprocessor 12.

At step 103, the microprocessor 12 judges whether the inputted unlocking signal is correct, if yes, the procedure proceeds to step 104, otherwise the procedure returns to step 101.

At step 104, the portable storage device 1 is unlocked, and the memory unit 13 can be accessed to retrieve/store data therein.

At step 105, the microprocessor 12 continues to sense and determines whether any input signals are being input via the key units 11; if yes, the procedure proceeds to step 106, otherwise the procedure remains in step 105 to continue sensing.

At step 106, the microprocessor 12 converts the input signals into the key signals corresponding to the keyboard, and transmits the key signals to the host end 2 via the transmission interface 14.

At step 107, the host end 2 receives the input signals that are identical to the keyboard and generates corresponding words or motions.

At step 108, whether or not to end the operation of the portable storage device 1 is determined, if yes, the procedure proceeds to step 109, otherwise the procedure returns to step 105.

At step 109, the procedure ends and the portable storage device 1 is locked and may be disconnected from the host end 2.

Accordingly, when the portable storage device 1 is locked, the user is denied access to the memory unit 13 so that retrieval/storage of data via the host end 2 can be effectively denied. To access the memory unit 13, the plurality of the key units 11 is be pressed to generate and transmit the correct unlocking signal to the microprocessor 12, which will compare and judge whether or not the unlocking signal is correct, wherein if the unlocking signal is correct, the portable storage device 1 is unlocked and allows access to the memory unit 13 via the host end 2 to process data retrieval/storage in the memory unit 13 via the transmission interface 14 and the microprocessor 12.

When the portable storage device 1 is unlocked, the key units 11 may be pressed to generate and transmit the input signals to the microprocessor 12 and the microprocessor 12 converts the input signals into the key signals corresponding to the keyboard which are then transmitted to the host end 2 via the transmission interface 14 to generate the corresponding words or motions. For example, if the key units 11 are number keys, 0 to 9, the user may press the number keys to generate the input signals corresponding to the numbers, and the microprocessor 12 converts the input signals into the key signals and transmits to the host end 2 and the host end 2 displays the numbers, 0 to 9 on a monitor or a program. However, it should be noted that the input signals generated by the key units 11 is merely used for demonstrating the embodiment of the present invention and therefore should not be used to limit the scope of the present invention. Accordingly, any equivalent component capable of generating equivalent input signals shall be construed within the scope of the present invention.

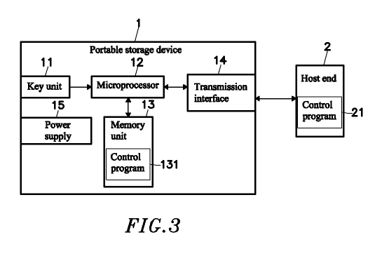

Referring to FIG. 3, the memory unit 13 comprises a control program 131. After the portable storage device 1 is electrically connected to the host end 2 via the transmission interface 14, the key units 11 may be pressed to generate and transmit corresponding input signals to the microprocessor 12 to unlock the memory unit 13. After the memory unit 13 is unlocked, the control program 131 is automatically executed and installed in the host end 2 and is adopted for sensing whether the transmission interface 14 receives any input signals. So that after the memory unit 13 is unlocked, the key units 11 may be pressed to generate and transmit input signals to the host end 2 via the microprocessor 12 and the transmission interface 14. The control program 21 of the host end 2 then receives the input signals and converts the input signals into the key signals corresponding to the keyboard to enable the host end 2 to generate the corresponding words or motions. For example, if the key units 11 are alphabet keys, A to Z, a user may press the alphabet keys to generate and transmit the input signals corresponding to the alphabets to the host end 2 and the control program 21 of the host end 2 converts the input signals into the key signal corresponding to the keyboard, and then the corresponding alphabets are displayed on a monitor or a program. However, it should be noted that the input signals generated by the key units 11 is merely used for demonstrating the embodiment of the present invention and therefore should not be used to limit the scope of the present invention. Accordingly, any equivalent component capable of generating equivalent input signals shall be construed within the scope of the present invention.

Accordingly, the portable storage device 1 of the present invention at least has the following advantages.

The key units 11 can be pressed for inputting and generating the input signals that are subsequently transmitted to the host end 2 and converted into the key signals of the keyboard after the portable storage device 1 is unlock. Thus, the key units 11 can function as a keyboard for inputting the words.

The key units 11 can function as a keyboard in cooperation with hardware (the microprocessor 12) and software (the control program 131).

While the invention has been described in conjunction with a specific best mode, it is to be understood that many alternatives, modifications, and variations will be apparent to those skilled in the art in light of the foregoing description. Accordingly, it is intended to embrace all such alternatives, modifications, and variations in which fall within the spirit and scope of the included claims. All matters set forth herein or shown in the accompanying drawings are to be interpreted in an illustrative and non-limiting sense.

What is claimed is:

1. A portable storage device with key outputting function, comprising:
a transmission interface, adopted for communicating with a host end;
a plurality of key units, adopted for generating and transmitting corresponding input signals;
a microprocessor, electrically connected to said transmission interface and said key units; and
a memory unit, electrically connected to said microprocessor, wherein said key units can transmit the corresponding input signals to said microprocessor to lock/unlock said memory unit, wherein after said memory unit is unlocked, said key units can continue to generate and transmit input signals to said microprocessor to convert said input signals into key signals corresponding to a keyboard and then said key signals are transmitted to said host end.

2. The portable storage device with key outputting function as claimed in claim 1, wherein said transmission interface is a wired or wireless type.

3. The portable storage device with key outputting function as claimed in claim 2, wherein said wired transmission interface comprises an institute of electrical and electronic engineers standard bus interface (IEEE1394), a universal serial bus (USB), a serial advanced technology attachment (SATA), an integrated device electronics (IDE) or a small computer standard interface (SCSI).

4. The portable storage device with key outputting function as claimed in claim 2, wherein said wireless transmission interface comprises Infrared, Bluetooth, ZigBee or WiFi.

5. The portable storage device with key outputting function as claimed in claim 1, wherein said key units comprises key switches, micro-switches, connective proximity switches, touch switches, voltage switches, capacitor switches or mechanical switches.

6. The portable storage device with key outputting function as claimed in claim 1, wherein said memory unit comprises an electrically programmable read only memory (EROM), an electrically erasable read only memory (EEROM), an erasable programmable read only memory (EPROM), an electrically erasable programmable read only memory (EEPROM), an flash memory (flash), an AND-flash memory, an OR-flash memory, a NAND flash memory or a hard disk drive (HDD).

7. The portable storage device with key outputting function as claimed in claim 1, wherein said memory unit comprises an auto-executable control program which upon execution will be installed in said host end, and wherein said control program senses and receives said input signals generated by said key units and converts said input signals into key signals corresponding to a keyboard.

8. The portable storage device with key outputting function as claimed in claim 1, wherein said host end comprises a personal computer, a notebook computer, a personal digital assistant (PDA) or an industrial computer.
